(19) United States
(12) Patent Application Publication
(10) Pub. No.: US 2014/0127988 A1
(43) Pub. Date: May 8, 2014

(54) ELECTRONIC DEVICE AND METHOD FOR IDENTIFYING LOCATION OF INTERESTED DEVICE

(71) Applicant: Samsung Electronics Co., Ltd, Gyeonggi-do (KR)

(72) Inventors: Hyuk Kang, Gyeonggi-do (KR); Jeong-Min Park, Gyeonggi-do (KR); Eui-Chang Jung, Seoul (KR); Eun-Jung Hyun, Seoul (KR)

(73) Assignee: Samsung Electronics Co., Ltd, Gyeonggi-do (KR)

(21) Appl. No.: 14/072,688

(22) Filed: Nov. 5, 2013

(30) Foreign Application Priority Data
Nov. 5, 2012 (KR) 10-2012-0124436

(51) Int. Cl. H04W 8/00; H04W 88/04

(52) U.S. Cl. CPC H04W 8/005; H04W 88/04
USPC 455/11.1

(57) ABSTRACT

A method identifies a location of an interested device. The method includes: transmitting first information of an interested device from a relay nearest to the electronic device among one or more relays; receiving second information of the interested device from the nearest relay; and displaying location information of the interested device based on the received second information.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Nov. 5, 2012 and assigned Serial No. 10-2012-0124436, the contents of which are incorporated herein by reference.

### TECHNICAL FIELD

The present disclosure relates to an electronic device and method for identifying a location of an interested counter device.

### BACKGROUND

As functions of an electronic device have been developed, the electronic device can monitor the location of an interested device in real time by attaching a tag to the interested device. The above-described technique is used in various fields, improving the convenience of a user. For example, parents can check a child's location in real time through the parents' electronic device by attaching a tag to the child's clothing or belongings.

However, since a communication range between another electronic device and a tag is not wide, a system including the electronic device and the tag is unsuitable to a preschool child that is distracted. In addition, when a person possessing a tag gets out of a communication range set with the electronic device, a person possessing an electronic device hardly listens to an alarm sound accurately. Furthermore, this causes the current consumption of the electronic device to be increased, resulting in an increase in the battery consumption of the electronic device. In addition, in a case where peripheral electronic devices are qualified to perform the function of a relay in order to increase the communication range between the tag and the electronic device, personal information is exposed, causing a problem that a privacy issue is raised.

Accordingly, although the tag is attached to a preschool child, there is a need for an apparatus and method for safely identifying the location information of a tag in an electronic device. Also, there is an urgent need for an apparatus and method for reducing battery consumption of the tag and the electronic device and increasing the communication range between the tag and the electronic device.

### SUMMARY

To address the above-discussed deficiencies of the prior art, it is a primary object to provide an apparatus and method for providing at least one relay between a tag and an electronic device, thereby increasing the communication range between the tag and the electronic device.

Another object of the present disclosure is to provide an apparatus and method for connecting one or more relays to one another through an encrypted communication channel, thereby preventing a privacy problem.

Another object of the present disclosure is to provide an apparatus and method for providing at least one relay between a tag and an electronic device, thereby performing communication without communication interference even in crowded and noisy environments.

Another object of the present disclosure is to provide an apparatus and method for performing communication between an electronic device and a relay nearest thereto in an encrypted packet form, thereby effectively improving user security.

Another object of the present disclosure is to provide an apparatus and method for using an existing tag without modification, thereby improving economic feasibility in terms of cost savings.

Another object of the present disclosure is to provide an apparatus and method for using an application suitable to a relevant area, thereby improving economic feasibility without the need for a relay to receive GPS location information.

Another object of the present disclosure is to provide an apparatus and method for using at least one relay provided between a tag and an electronic device as a mobile relay that is not always fixed and is movable when required, thereby improving user convenience.

Another object of the present disclosure is to provide an apparatus and method for using Bluetooth low energy technology for a tag and an electronic device, thereby reducing battery consumption.

According to an embodiment of the present disclosure, a method for operating an electronic device includes: transmitting first information of an interested device from a relay nearest to the electronic device among one or more relays; receiving second information of the interested device from the nearest relay; and displaying location information of the interested device based on the received second information.

The method can further include executing an application for identifying the location information of the interested device.

The method can further include: searching for the nearest relay among the one or more relays and connecting to the searched nearest relay.

The one or more layers can be connected to one another through an encrypted communication channel.

The first information of the interested device can be ID information of the interested device.

The second information of the interested device can be ID information of the interested device, and ID information and location information of a relay nearest to the interested device among the one or more relays.

Transmitting the first information of the interested relay and receiving the second information of the interested device from the nearest relay can be performed in an encrypted packet form.

Displaying the location information of the interested device based on the received second information can include: identifying location information of a relay nearest to the interested device included in the second information; and displaying the location information of the relay nearest to the interested device and the location information of the interested device together.

According to another embodiment of the present disclosure, a method for operating a relay nearest to a device among one or more relays includes: receiving information of the device from the device at predetermined periods; and transmitting the received first information to the relay nearest to the device among the one or more relays.

The information of the device can be the ID information of the device.

According to another embodiment of the present disclosure, a method for operating a relay nearest to an electronic device among one or more relays includes: receiving first information from the electronic device; and transmitting the second information received from at least one relay nearest to the relay among the one or more relays to the electronic device.

The method can further include: receiving the second information from the at least one relay nearest to the relay at predetermined periods; and storing the received second information.

The first information can be the ID information of the interested device.

The second information can be ID information of the interested device, and ID information and location information of a relay nearest to the interested device.

The one or more layers can be connected to one another through an encrypted communication channel.

Receiving the first information from the electronic device and transmitting the second information received from the at least one relay nearest to the relay among the one or more relays to the electronic device can be performed in an encrypted packet form.

According to another embodiment of the present disclosure, an electronic device, includes: a communication module for transmitting first information of an interested device to a relay nearest to the electronic device among one or more relays and receiving second information of the interested device; and a touchscreen for displaying location information of the interested device based on the received second information.

According to another embodiment of the present disclosure, a relay nearest to a device among one or more relays, includes: a communication module for receiving information of the device from the device at predetermined periods, and transmitting the received first information to at least one relay nearest to the relay among the one or more relays; and a control unit for controlling an overall operation of the relay.

The electronic device can further include a processor unit for executing an application for identifying the location information of the interested device.

The communication module can search for the relay nearest to the electronic device among one or more relays and can connect to the searched nearest relay.

The one or more layers can be connected to one another through an encrypted communication channel.

The first information of the interested device can be the ID information of the interested device.

The second information of the interested device can be ID information of the interested device, and ID information and location information of a relay nearest to the interested device among the one or more relays.

The communication module can perform communication in an encrypted packet form.

The electronic device can further include a processor unit for identifying location information of a relay nearest to the interested device included in the second information. The touchscreen can display the location information of the relay nearest to the interested device and the location information of the interested device together.

The information of the device can be ID information of the device.

According to another embodiment of the present disclosure, a relay nearest to an electronic device among one or more relays, includes: a communication module for receiving first information from the electronic device and transmitting a second information received from at least one relay nearest to the relay among the one or more relays to the electronic device; and a control unit for controlling an overall operation of the relay.

The relay can further include a storage unit for storing the received second information. The communication module can receive the second information from the at least one relay nearest to the relay at predetermined periods.

The first information can be the ID information of the interested device.

The second information can be ID information of the interested device, and ID information and location information of a relay nearest to the interested device.

The one or more layers can be connected to one another through an encrypted communication channel.

The communication module may perform communication in an encrypted packet form.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device for identifying a location of an interested device;

FIG. 2 illustrates an exemplary embodiment of an electronic device for receiving location information of an interested device from a relay;

FIG. 3 illustrates an exemplary embodiment in which the location information of an interested device is displayed;

FIG. 4 illustrates an operation sequence of an electronic device according to an exemplary embodiment of the present disclosure;

FIG. 5 illustrates an operation sequence of a relay nearest to an interested device according to an exemplary embodiment of the present disclosure;

FIG. 6 illustrates an operation sequence of a relay nearest to an electronic device according to an exemplary embodiment of the present disclosure;

FIG. 7 illustrates an operation sequence between an interested device, a relay, and an electronic device according to an exemplary embodiment of the present disclosure;

FIG. 8A illustrates a method for an electronic device to identify a location of an interested device according to an exemplary embodiment of the present disclosure;

FIG. 8B illustrates a configuration of an electronic device for identifying a location of an interested device according to an exemplary embodiment of the present disclosure;

FIG. 9 illustrates a configuration of an electronic device according to an embodiment of the present disclosure;

FIG. 10 illustrates a configuration of an interested device according to an exemplary embodiment of the present disclosure; and

FIG. 11 illustrates a configuration of a relay according to an exemplary embodiment of the present disclosure.

### DETAILED DESCRIPTION

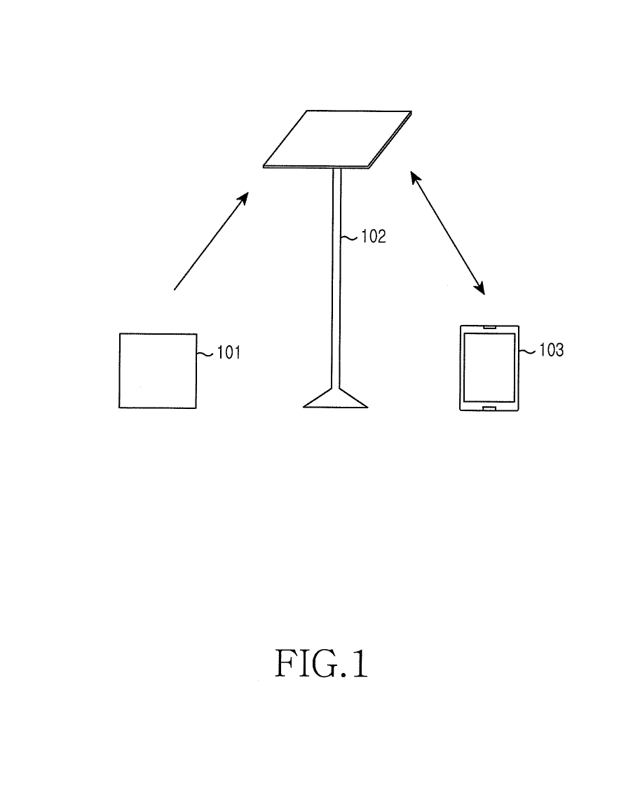

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein must be understood based on the descriptions made herein.

FIG. 1 illustrates an electronic device for identifying a location of an interested device according to an exemplary embodiment of the present disclosure. Referring to FIG. 1, the present disclosure can include an interested device 101, a relay 102, and an electronic device 103. First, the interested device 101 is a device of which the location information that continuously changes with time is to be identified by the electronic device 103. The interested device 101 transmits its own location information to the relay 102 at predetermined periods. Specifically, the interested device 101 can transmit its own location information to the relay 102 that is nearest to the interested device 101 among one or more relays at predetermined periods so as for the electronic device 103 to identify the location information of the interested device. Herein, the location information, which the interested device 101 transmits at predetermined periods to the relay 102 that is nearest to the interested device 101 among the one or more relays, can include the ID information of the interested device. That is, the interested device 101 can be attached to an arbitrary device in order for the electronic device 103 to identify the location information of the interested device 101 which continuously changes with time. In one embodiment, the interested device 101 can be attached to, for example, a vehicle that is parked in the parking lot of a shopping mall, and the electronic device 103 can identify the location information of the interested device 101. In the above embodiment, the electronic device 103 can identify the location information of the interested device 101 and can easily display the location information of the vehicle that is parked in the parking lot of the shopping mall. In this embodiment, the interested device 101 is attached to, for example, the clothing of a child which visits an amusement park with the child's parents, and the electronic device 103 possessed by the parents can identify the location information of the interested device 101. In the above embodiment, the electronic device 103 can identify the location information of the interested device 101, which continuously changes with time and can easily display the location information of the child in a crowd. That is, the interested device 101 can transmit its own ID information to the relay 102 that is nearest to the interested device 101 among the one or more relays at predetermined periods, thereby enabling the electronic device 103 to identify the location information of the interested device. According to the present disclosure, the interested device 101 can be implemented by using another device without modification, thereby improving economic feasibility in terms of cost savings. For example, a tag that serves as the interested device 101 can be attached to a child's belongings or a vehicle without requiring an additional device as it is, thereby improving economic feasibility in terms of cost savings.

A plurality of relays 102 can be provided. The relay 102 can be defined as a relay that is located between the interested device 101 and the electronic device 103 to allow the interested device 101 and the electronic device to communicate with each other. Specifically, the relay 102 can receive the location information of the interested device 101 from the interested device 101 at predetermined periods and transmit the location information of the interested device 101 to the electronic device 103 by communicating with the electronic device 103. First, the relay 102 nearest to the interested device 101 can receive the location information of the interested device 101 from the interested device 101 at predetermined periods, and transmit the received location information of the interested device 101 to at least one relay nearest to the relay 102. In addition, the relay 102 nearest to the electronic device 103 can receive a request for the location information of the interested device 101 from the electronic device 103 and transmit the location information of the interested device 101 to the electronic device 103. Specifically, the relay 102 nearest to the electronic device 103 among one or more relays can receive the ID information of the interested device 101 from at least one relay nearest to the relay 102. Thereafter, when the relay 102 nearest to the electronic device 103 receives the ID information of the interested device 101 from the electronic device 103, the relay 102 can transmit the ID information of the interested device 101 which is received from the at least one relay nearest to the relay 102 to the electronic device 103.

In addition, the relay 102 can receive the request for the location information of the interested device 101 from the electronic device 103 and transmit the location information of the interested device 101, the ID information of the relay 102, and the location information of the relay 102 to the electronic device 103. Specifically, when the relay 102 receives the ID information of the interested device 101 from the electronic device 103, the relay 102 can transmit the ID information of the interested device 101, the ID information of the relay 102, and the location information of the relay 102, which are received from the interested device 101, to the electronic device 103. Herein, the relay 102 can transmit and receive information with respect to the electronic device 103 in an encrypted packet form. Specifically, since the relay 102 transmits and receives information to and from the electronic device 103 in the encrypted packet form, information transmitted from the relay 102 to the electronic device 103 and information received from the electronic device 103 are not exposed to a third party. That is, a relay without this feature transmits and receives information to and from the electronic device in an unencrypted packet form, raising a privacy issue. In one example, the interested device for transmitting its own location at predetermined periods is attached to a child's belongings, and parents' electronic device displays the location information of the interested device in real time. In the above example, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the present disclosure, the relay transmits and receives information to and from the electronic device in the encrypted packet form, addressing the privacy issue.

In addition, according to the present disclosure, the relay 102 provided between the interested device 101 and the electronic device 103 is used as a mobile relay that is not always fixed and is movable when required, thereby improving user convenience. For example, the communication range between the interested device 101 and the electronic device 103 can be increased by attaching the relay 102 to a user's vehicle or a certified person's vehicle. That is, the relay 102 according to the present disclosure not only serves as a fixed relay, but also serves as a mobile relay when being attached to a vehicle, thereby coping with a situation in which a wide-range communication is required.

The electronic device 103 can be defined as a device for identifying the location information of the interested device 101 by transmitting and receiving information to and from the relay 102. Specifically, the electronic device 103 can transmit the ID information of the interested device to the relay 102 and receive the ID information of the interested device 101, and the ID information and location information of the relay. Next, the electronic device 103 can display the location information of the interested device 101. First, the electronic device 103 can receive an input for execution of an application for identifying the location information of the interested device 101 and execute the application. Thereafter, when the electronic device 103 receives an instruction for identification of the location information of the interested device 101, the electronic device 103 can transmit the ID information of the interested device 101 to the relay 102. When transmitting the ID information of the interested device 101 to the relay 102, the electronic device 103 can receive the ID information of the interested device 101, the ID information of the relay 102, and the location information of the relay 102 from the relay 102. Thereafter, the electronic device 103 can display the location information of the interested device 101 on a touchscreen according to a relevant application.

In addition, according to the present disclosure, battery consumption can be reduced by using Bluetooth low energy technology for the interested device 101 and the electronic device 103. For example, when using Bluetooth low energy technology, the interested device 101 can increase a battery replacement period and the electronic device 103 can perform scanning continuously at low power by address filtering through a white list. Specifically, since the electronic device 103 filters out only the address of the interested device 101 that is a certified address, the electronic device 103 can perform scanning continuously at low power. Herein, the interested device 101 and the electronic device 103 can use various communications, which is not limited to the Bluetooth low energy technology. For example, the electronic device and the interested device can connect to each other through various communications, such as UMTS (Universal Mobile Telecommunications System), LIE (Long Term Evolution), WIFI (wireless fidelity) and ZigBee.

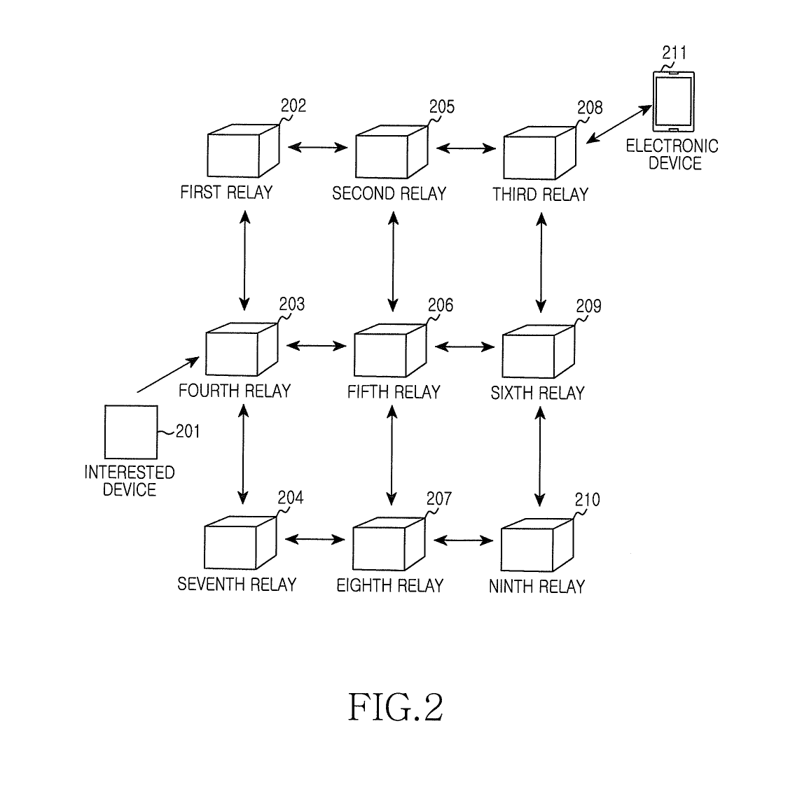

FIG. 2 illustrates an exemplary embodiment of an electronic device for receiving the location information of an interested device from a relay according to the present disclosure. As illustrated in FIG. 2, the present embodiment can include an interested device 201, one or more relays 202 to 210, and an electronic device 211. In this case, in one embodiment, the interested device 201 and the electronic device 211 share their ID information with each other through a Bluetooth pairing process, and nine relays are connected to one another.

First, in the above embodiment, the interested device 201 can transmit the ID information of the interested device 201 to a fourth relay 203 nearest to the interested device 201 at predetermined periods. Thereafter, the fourth relay 203 that receives the ID information of the interested device 201 from the interested device 201 can transmit the ID information of the interested device 201 received from the interested device 201, its own ID information, and the its own location information to at least one relay 202, 206 and 204 nearest to the fourth relay 203. Specifically, the fourth relay 203 which receives the ID information of the interested device 201 can transmit the ID information of the interested device 201, the ID information of the fourth relay 203, and the location information of the fourth relay 203 to the three relays 202, 204 and 206 nearest to the fourth relay 203 among the nine relays 202 to 210 connected to one another. Herein, the nine relays 202 to 210 connected to one another can be connected through an encrypted communication channel. Specifically, the nine relays 202 to 210 that relay between the interested device 201 and the electronic device 211 are connected to one another through the encrypted communication channel. Therefore, other electronic devices than the registered electronic device 211 hardly receive information about the interested device 201.

Thereafter, a first relay 202, a fifth relay 206, and a seventh relay 204 which receive the ID information of the interested device 201, the ID information of the fourth relay 203, and the location information of the fourth relay 203 from the fourth relay 203 can transmit the ID information of the interested device 201, the ID information of the fourth relay 203, and the location information of the fourth relay 203 to a second relay 205, a sixth relay 209, and an eighth relay 207 which are nearest, respectively, to the first relay 202, the fifth relay 206, and the seventh relay 204. Similarly, the second relay 205, the fifth relay 206, and the eighth relay 207 can transmit the ID information of the interested device 201, the ID information of the fourth relay 203, and the location information of the fourth relay 203 to the third relay 208, the sixth relay 209, and the ninth relay 210, allowing the nine relays 202 to 210 to share the ID information of the interested device 201, the ID information of the fourth relay 203 that is nearest to the interested device, and the location information of the fourth relay 203.

Thereafter, the electronic device can receive an input for execution of an application for displaying the location information of the interested device 201 on the touchscreen of the electronic device and perform the application. When the electronic device 211, which executes the application, receives an instruction for displaying the location information of the interested device, the electronic device 211 can search for a relay nearest to the electronic device 211 among the nine relays 202 to 210 and can connect to the searched nearest relay. In the present embodiment, since the relay nearest to the electronic device is the third relay 208, the electronic device 211 can connect to the third relay 208. When connected to the third relay 208 for near field communication, the electronic device 211 can transmit the ID information of the interested device 201, of which the location information is to be identified, to the third relay 208.

In this case, the third relay 208 can transmit and receive information with respect to the electronic device 211 in an encrypted packet form. Specifically, since the third relay 208 transmits and receives information to and from the electronic device 211 in an encrypted packet form, there is an advantage that information transmitted to the electronic device 211 by the third relay 208 and information received from the electronic device 211 are not exposed to a third party. That is, another relay transmits and receives information to and from the electronic device in an unencrypted packet form, raising a privacy issue. For example, in one embodiment, the interested device that transmits its own location at predetermined periods is attached to a child's belongings, and parents' electronic device displays the location information of the interested device in real time. In the above embodiment, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the present disclosure, the relay transmits and receives information to and from the electronic device in an encrypted packet form, addressing the privacy issue.

Thereafter, the relay 208 nearest to the electronic device can transmit the ID information of the interested device 201, and the ID information and location information of the relay 203 nearest to the interested device 201, which are received from the relay 205 or 209 nearest to the relay 208 among neighboring relays, to the electronic device 211. For example, the third relay 208 that receives the ID information of the interested device from the electronic device 211 can transmit the ID information of the interested device 201, the ID information of the fourth relay 203, and the location information of the fourth relay 203, which are received from the second relay 205 or sixth relay 209 nearest to the relay 208, to the electronic device 211.

When receiving the ID information of the interested device 201, and the ID information and location information of the relay nearest to the interested device 201 from the relay nearest to the electronic device, the electronic device 211 can display the location information of the interested device 201. For example, when receiving the ID information of the interested device 201, and the ID information and location information of the fourth relay nearest to the interested device 201 from the third relay 208 nearest to the electronic device, the electronic device 211 can display the location information of the interested device 201.

According to the present disclosure, an interested device can be used without modification and at least one relay provided between the interested device and the electronic device needs not to receive its own GPS location information, enabling low cost. According to the present disclosure, the interested device can be used without modification, improving economic feasibility in terms of cost savings. For example, a tag that serves as the interested device can be attached to a child's belongings or a vehicle without requiring an additional device as it is, thereby improving economic feasibility in terms of cost savings. In addition, since at least one relay provided between the interested device and the electronic device does not need to receive the GPS location information of respective relays, low cost can be enabled although many relays are arranged in a specific area.

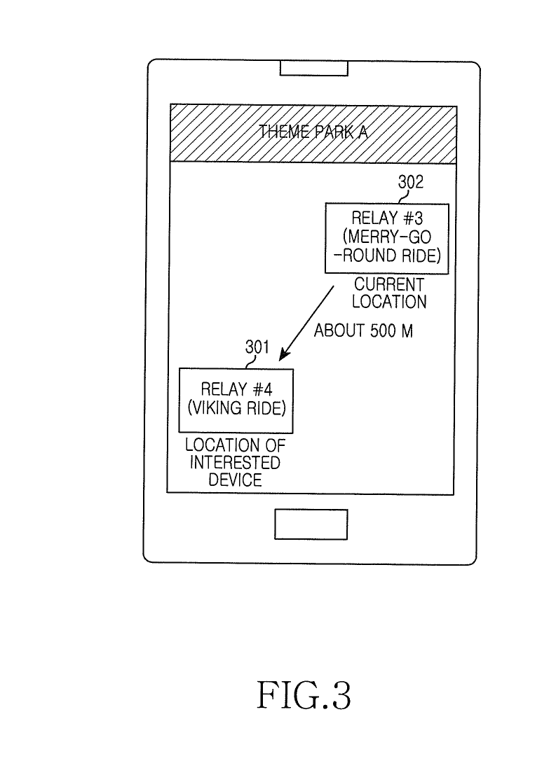

FIG. 3 illustrates an exemplary embodiment in which the location information of an interested device is displayed according to the present disclosure. First, in one embodiment, the electronic device has executed a relevant application by receiving an input for execution of the application for displaying the location information of the interested device, a relay nearest to the interested device is the fourth relay 301, and a relay nearest to the electronic device is the third relay 302. In addition, in one embodiment, the interested device is attached to a child's belongings, the electronic device is possessed by parents, and the child and the parents are located at a theme park A. In the above embodiment, in a case where the electronic device receives an instruction for displaying the location of the interested device, the electronic device can search for a relay nearest to the electronic device and can then check that the third relay 302 is nearest to the electronic device. Thereafter, the electronic device can transmit the ID information of the interested device to the third relay 302. The third relay 302 that has received the ID information of the interested device can transmit the ID information of the interested device, and the ID information and location information of the fourth relay 301 that is a relay nearest to the interested device, which are received from at least one relay adjacent to the third relay 302.

Thereafter, the electronic device can receive the ID information of the interested device, and the ID information and location information of the fourth relay 301 that is a relay nearest to the interested device and display the location information of the interested device on the touchscreen of the electronic device. As illustrated in FIG. 3, the electronic device can display indication that the electronic device is located near the third relay 302 among one or more relays provided in the theme park A, and the third relay 302 is located near “a merry-go-round ride” on the touchscreen of the electronic device. In addition, the electronic device can display an indication that the electronic device is located near the fourth relay 301 among one or more relays provided in the theme park A, and the fourth relay 301 is located near “a Viking ride” on the touchscreen of the electronic device. Furthermore, the electronic device can display indication that a distance from the “merry-go-round ride” near the third relay 302, at which the electronic device is currently located, to “the Viking ride” near the fourth relay 301, at which the interested device is located, is about 500 m. Accordingly, the parents possessing the electronic device can accurately find the location of the child to which the interested device is attached even in a crowded area, such as a theme park.

The applications can be displayed on the touchscreen of the electronic device respectively according to areas. Specifically, when the electronic device downloads and stores an application for identifying the location information of the interested device, the electronic device can receive GPS location information and execute applications according to respective places. For example, when the electronic device is located at the theme park A, the electronic device can automatically execute the application for identifying the location information of the theme park A. Similarly, when the electronic device is located at a shopping mall B, the electronic device can automatically execute the application for identifying the location information of the shopping mall B. That is, one or more relays are separately installed in respective places. Therefore, when the electronic device executes an application for each place, the relays can exchange the location information of the electronic device with the interested device. In this case, since the one or more relays installed in the respective places do not require GPS location information, the relays can be installed in respective places at low cost. That is, the one or more relays receive the ID information of the interested device and share the received ID information of the interested device and the ID information and location information of a relay nearest to the interested device with one another. The one or more relays have only to transmit and receive information about the electronic device and the interested device, enabling low cost production.

When another electronic device wants to identify the location of the interested device, a distance is about 50 m, which is very short. As described above, if the theme park is an indoor theme park, communication is not effectively performed. Accordingly, when a relay that performs a relay function is not provided, the electronic device hardly identifies the location of the interested device accurately. When a relay which relays between the interested device and the electronic device is provided, another relay can transmit and receive information to and from the electronic device in an unencrypted packet form, raising a privacy issue. In one example, the interested device for transmitting its own location at predetermined periods is attached to a child's belongings, and a parent's electronic device displays the location information of the interested device in real time. In the above embodiment, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the present disclosure, the relay transmits and receives information to and from the electronic device in the encrypted packet form, addressing the privacy issue.

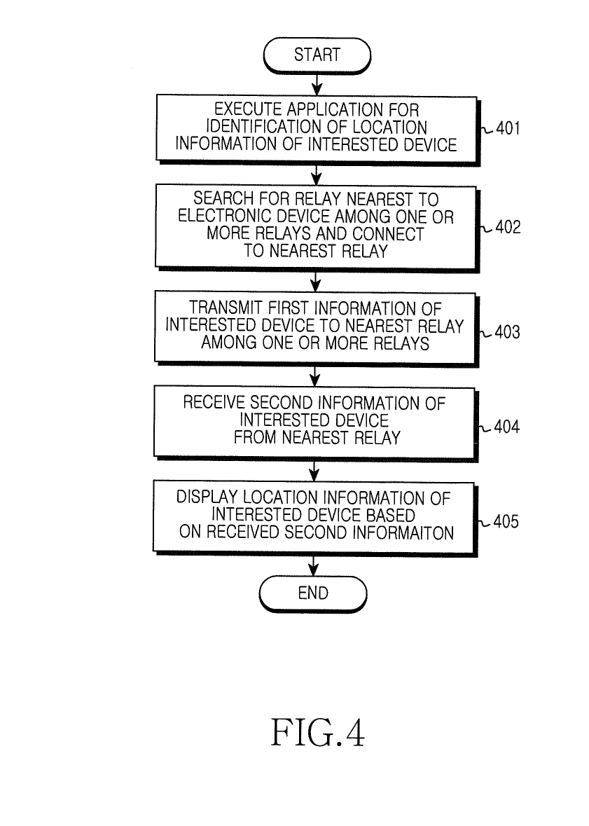

FIG. 4 illustrates an operation sequence of an electronic device according to an exemplary embodiment of the present disclosure. First, as illustrated in FIG. 4, the electronic device can execute an application for identification of the location information of an interested device (step 401). Specifically, when the electronic device downloads and stores the application for identifying the location information of the interested device, the electronic device can receive GPS location information and execute applications according to respective places. For example, when the electronic device is located at the theme park A, the electronic device can automatically execute the application for identifying the location information of the theme park A. Similarly, when the electronic device is located at a shopping mall B, the electronic device can automatically execute the application for identifying the location information of the shopping mall B.

After having executed the application, the electronic device can search for a relay nearest to the electronic device among one or more relays and can connect to the nearest relay (step 402). For example, in one embodiment, there are twenty relays that relay between the interested device and the electronic device. In the above embodiment, the electronic device can search for a relay nearest to the electronic device among the twenty relays and can connect to the searched nearest relay for communication.

Thereafter, the electronic device can transmit the first information of the interested device to the nearest relay among one or more relays (step 403). Herein, the first information can be the ID information of the interested device. Specifically, the electronic device can transmit the ID information of the interested device to the nearest relay that connects to the electronic device in order to identify the location information of the interested device.

When transmitting the first information of the interested device to the nearest relay, the electronic device can receive the second information of the interested device from the nearest relay (step 404). Herein, the second information can be the ID information of the interested device, and the ID information and location information of a relay nearest to the interested device. Specifically, the electronic device can receive the ID information of the interested device, and the ID information and location information of the relay nearest to the interested device from the relay nearest to the electronic device among one or more relays. Herein, the electronic device can transmit and receive information to and from a relay nearest to the electronic device in the encrypted packet form. Specifically, since the electronic device and the relay transmit and receive information to and from each other in the encrypted packet form, information transmitted from the electronic device to the relay and information received from the relay is not exposed to a third party. Since another electronic device transmits and receives information to and from a relay in an unencrypted packet form, raising a privacy issue. For example, in one embodiment, the interested device for transmitting its own location at predetermined periods is attached to a child's belongings, and a parent's electronic device displays the location information of the interested device in real time. In the above embodiment, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the present disclosure, the relay transmits and receives information to and from the electronic device in the encrypted packet form, addressing the privacy issue.

Thereafter, the electronic device can display the location information of the interested device based on the received second information (step 405). For example, in one embodiment, the electronic device receives an input for execution of a relevant application for displaying the location information of the interested device and then executes the application, a relay nearest to the interested device is a first relay and a relay nearest to the electronic device is a second relay. In addition, in one embodiment, the interested device is attached to a child's clothing, the electronic device is possessed by parents, and the child and the parents are currently located at a shopping mall A. In the above embodiment, when the electronic device receives the second information from the nearest relay, the electronic device can display an indication that the electronic device is currently located near a second relay among one or more relays provided in the shopping mall A and the second relay is located near “a shoes shop B” located in the second floor of the shopping mall on the touchscreen of the electronic device. In addition, the electronic device can display an indication that the interested device is currently located near a first relay among one or more relays provided in the shopping mall A and the first relay is located near “a toy shop” located in the fifth floor of the shopping mall on the touchscreen of the electronic device. In addition, the electronic device can display an indication that a distance from “the shoes shop B” located near the second relay at which the electronic device is located to “the toy shop” located near the first relay at which the interested device is located is a three-floor distance on the touchscreen of the electronic device. Accordingly, the electronic device possessed by the electronic device can accurately find the location of the child to which the interested device is attached even in the crowded area, such as the shopping mall.

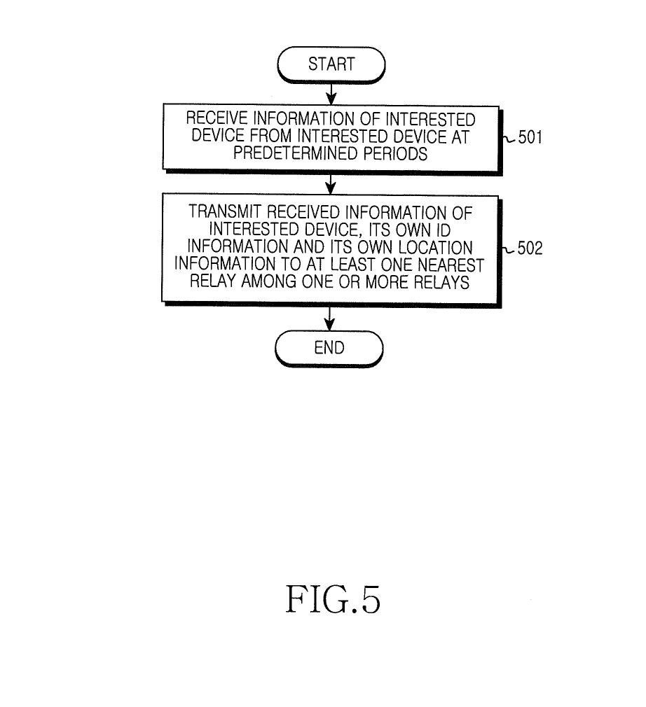

FIG. 5 illustrates an operation sequence of a relay nearest to an interested device according to an exemplary embodiment of the present disclosure. First, as illustrated in FIG. 5, a relay nearest to an interested device can receive the information of the interested device from the interested device at predetermined periods (step 501). Herein, the information of the interested device can be the ID information of the interested device. Specifically, the relay nearest to the interested device can receive the ID information of the interested device from the interested device at predetermined periods.

Thereafter, the relay nearest to the interested device can transmit the received information of the interested device, its own ID information, and its own location information to at least one relay nearest to the relay among one or more relays (step 502). Specifically, the relay nearest to the interested device can transmit the ID information of the interested device, its own ID information, and its own location information to at least one relay, nearest to the relay and connected to the relay through an encrypted communication channel, among one or more relays. The ID information of the interested device, and the ID information and location information of the relay is shared between one or more relays connected through the encrypted communication channel and provided between the interested device and the electronic device.

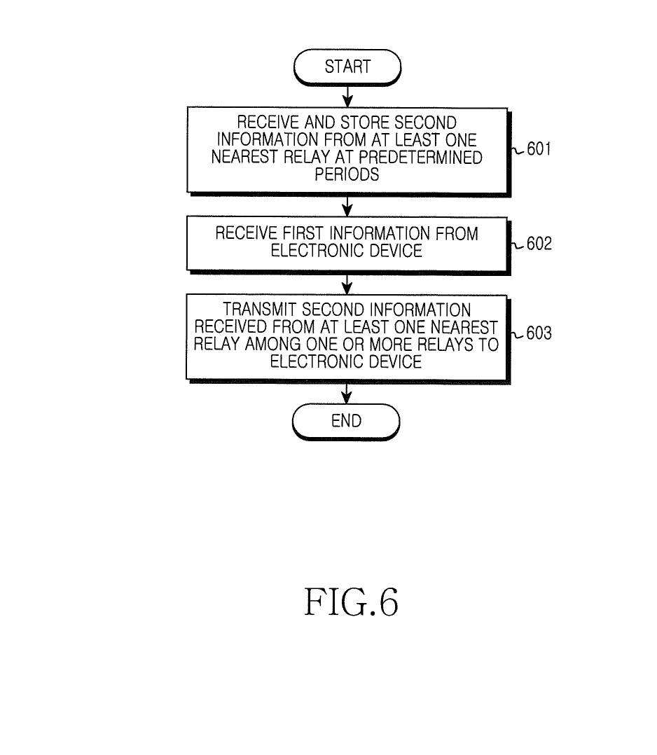

FIG. 6 illustrates an operation sequence of a relay nearest to an electronic device according to an exemplary embodiment of the present disclosure. First, as illustrated in FIG. 6, a relay nearest to an electronic device can receive and store second information from at least one relay nearest to the relay at predetermined periods (step 601). Herein, the second information can be the ID information of the interested device, and the ID information and location information of a relay nearest to the interested device. Specifically, the relay nearest to the electronic device can receive and store the ID information of the interested device, and the ID information and location information of the relay nearest to the interested device from the relay nearest to the interested device. That is, since the location of the interested device continuously changes with time, the relay nearest to the electronic device can receive and store the ID information of the interested device, and the ID information and location information of the relay nearest to the interested device at predetermined periods.

Thereafter, the relay neatest to the electronic device can receive first information from the electronic device (step 602). Herein, the first information can be the ID information of the interested device. Specifically, the relay nearest to the electronic device can receive the ID information of the interested device from the electronic device.

The relay that receives the ID information of the interested device from the electronic device and is nearest to the electronic device can transmit the second information received from at least one relay nearest to the relay among one or more relays (step 603). Specifically, the relay nearest to the electronic device can transmit the ID information of the interested device, and the ID information and location information of the relay nearest to the interested device, which are received from the relay nearest to the interested device, to the electronic device.

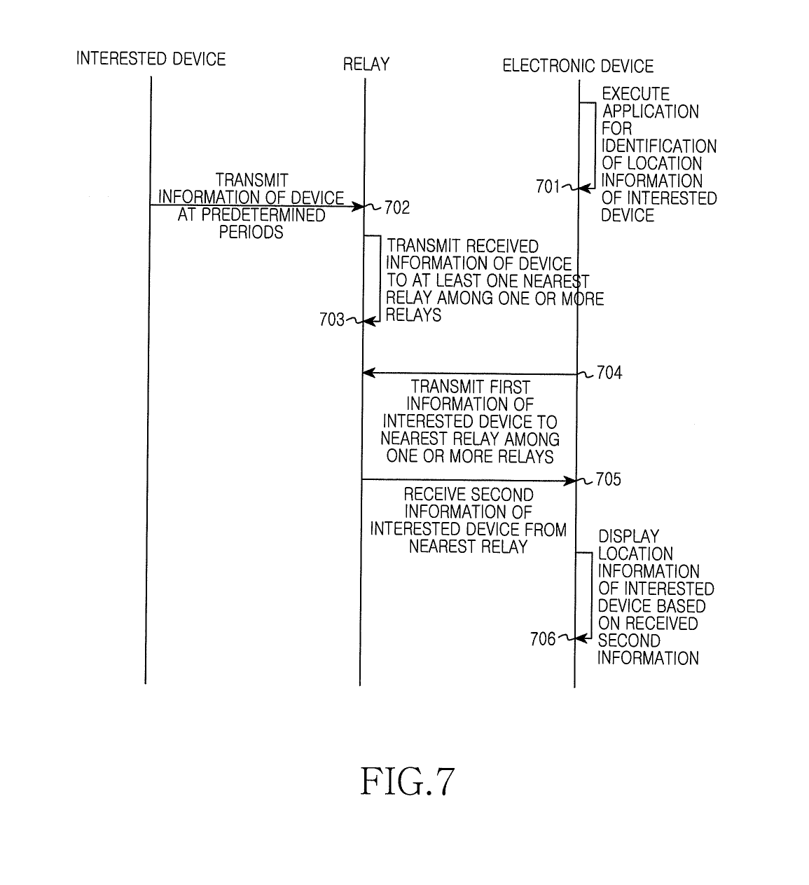

FIG. 7 illustrates an operation sequence between an interested device, a relay and an electronic device according to an exemplary embodiment of the present disclosure. First, as illustrated in FIG. 7, the electronic device can execute an application for identification of the location information of an interested device (step 701). Specifically, when receiving an input for execution of an application for identifying the location information of the interested device, the electronic device can receive the location information of the electronic device from GPS satellites and execute an application available in the current location of the electronic device.

Thereafter, the interested device can transmit the information of the device to a relay nearest to the interested device among one or more relays at predetermined periods (step 702). Herein, the information of the device can be the ID information of the device. Specifically, the interested device can transmit its own ID information to a relay nearest to the interested device among one or more relays.

The relay that has received the location information of the device from the interested device can transmit the received information of the device to at least one relay nearest to the relay among one or more relays (step 703). Specifically, when the relay nearest to the interested device receives the ID information of the device from the interested device, the relay nearest to the interested device can transmit the ID information of the interested device, its own ID information, and its own location information to at least one relay nearest to the relay among one or more relays. Herein, the at least one relay that relays between the interested device and the electronic device can transmit and receive information through an encrypted communication channel.

Thereafter, the electronic device can transmit the first information of the interested device to a relay nearest to the electronic device among one or more relays (step 704). Herein, the first information can be the ID information of the interested device. Specifically, the electronic device can transmit the ID information of the interested device to the relay nearest to the electronic device among one or more relays. Herein, the relay nearest to the electronic device can transmit and receive information in an encrypted packet form. Another relay transmits and receives information to and from the electronic device in an unencrypted packet form, raising a privacy issue. For example, in one embodiment, the interested device for transmitting its own location at predetermined periods is attached to a child's belongings, and a parent's electronic device displays the location information of the interested device in real time. In the above embodiment, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the disclosure, the relay transmits and receives information to and from the electronic device in the encrypted packet form, addressing the privacy issue.

Thereafter, the electronic device can receive the second information of the interested device from the relay nearest to the electronic device (step 705). Herein, the second information can be the ID information of the interested device, and the ID information and location information of a relay nearest to the interested device. Specifically, the electronic device can receive the ID information of the interested device, and the ID information and location information of the relay nearest to the interested device from the relay nearest to the electronic device.

When receiving the second information of the interested device from the nearest relay, the electronic device can display the location information of the interested device based on the received second information (step 706). For example, in one embodiment, the electronic device receives an input for execution of a relevant application for displaying the location information of the interested device and then executes the application, a relay nearest to the interested device is a first relay and a relay nearest to the electronic device is a second relay. In addition, in one embodiment, the interested device is attached to a child's clothing, the electronic device is possessed by parents, and the child and the parents are currently located at a shopping mall A. In the above embodiment, when the electronic device receives the second information from the nearest relay, the electronic device can display an indication that the electronic device is currently located near a second relay among one or more relays provided in the shopping mall A and the second relay is located near “a shoes shop B” located in the second floor of the shopping mall on the touchscreen of the electronic device. In addition, the electronic device can display an indication that the interested device is currently located near a first relay among one or more relays provided in the shopping mall A and the first relay is located near “a toy shop” located in the fifth floor of the shopping mall on the touchscreen of the electronic device. In addition, the electronic device can display an indication that a distance from “the shoes shop B” located near the second relay at which the electronic device is located to “the toy shop” located near the first relay at which the interested device is located is a 3-floor distance on the touchscreen of the electronic device. Accordingly, the electronic device possessed by the electronic device can accurately find the location of the child to which the interested device is attached even in the crowded area, such as the shopping mall.

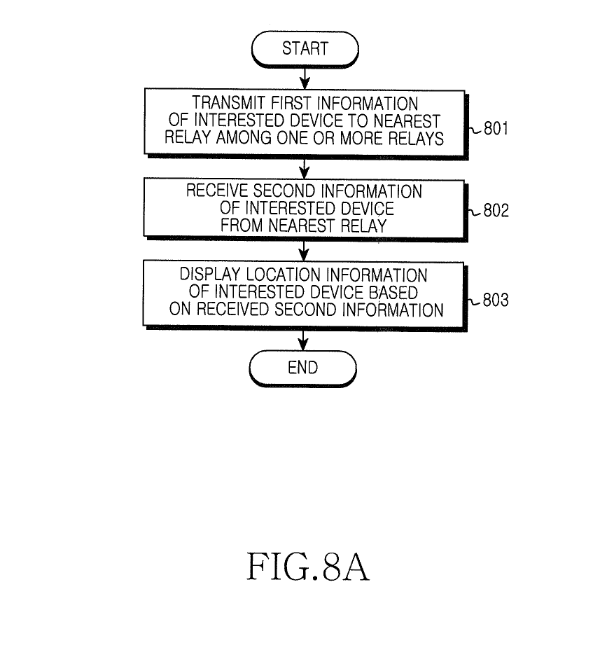

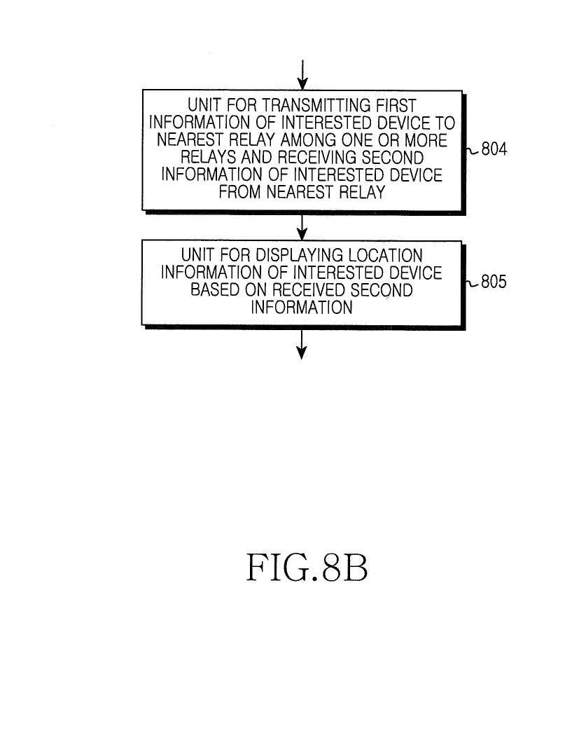

FIG. 8A illustrates a method for an electronic device to identify a location of an interested device according to an exemplary embodiment of the present disclosure. First, the electronic device can transmit the first information of the interested device to a relay nearest to the electronic device among one or more relays (step 801). Herein, the first information can be the ID information of the interested device. Specifically, the electronic device can transmit the ID information of the interested device to the relay nearest to the electronic device among the one or more relays. Herein, the relay nearest to the electronic device can transmit and receive information in the encrypted packet form. Another relay transmits and receives information to and from the electronic device in an unencrypted packet form, raising a privacy issue. For example, in one embodiment, the interested device for transmitting its own location at predetermined periods is attached to a child's belongings, and a parent's electronic device displays the location information of the interested device in real time. In the above embodiment, when a relay for allowing the interested device and the electronic device to communicate with each other is a third party's electronic device, the child's location is exposed to the third party, which is unfit for the purpose of preventing a missing child. That is, in the case of using at least one electronic device possessed by an unidentified third party as a relay, there is a problem that the location of the child is exposed to the third party. On the contrary, according to the present disclosure, the relay transmits and receives information to and from the electronic device in the encrypted packet form, addressing the privacy issue.

Thereafter, the electronic device can receive the second information of the interested device from the relay nearest to the electronic device (step 802). Herein, the second information can be the ID information of the interested device, and the ID information and location information of a relay nearest to the interested device. Specifically, the electronic device can receive the ID information of the interested device, and the ID information and location information of the relay nearest to the interested device from the relay nearest to the electronic device.

Thereafter, the electronic device can display the location information of the interested device based on the received second information (step 803). For example, in one embodiment, the electronic device receives an input for execution of a relevant application for displaying the location information of the interested device and then executes the application, a relay nearest to the interested device is a first relay and a relay nearest to the electronic device is a second relay. In addition, in one embodiment, the interested device is attached to a child's clothing, the electronic device is possessed by parents, and the child and the parents are currently located at a shopping mall A. In the above embodiment, when the electronic device receives the second information from the nearest relay, the electronic device can display an indication that the electronic device is currently located near a second relay among one or more relays provided in the shopping mall A and the second relay is located near “a shoes shop B” located in the second floor of the shopping mall on the touchscreen of the electronic device. In addition, the electronic device can display an indication that the interested device is currently located near a first relay among one or more relays provided in the shopping mall A and the first relay is located near “a toy shop” located in the fifth floor of the shopping mall on the touchscreen of the electronic device. In addition, the electronic device can display an indication that a distance from “the shoes shop B” located near the second relay at which the electronic device is located to “the toy shop” located near the first relay at which the interested device is located is a three-floor distance on the touchscreen of the electronic device. Accordingly, the electronic device possessed by the electronic device can accurately find the location of the child to which the interested device is attached even in the crowded area, such as the shopping mall.

FIG. 8B illustrates a configuration of an electronic device for identifying a location of an interested device according to an exemplary embodiment of the present disclosure. First, the communication module (804) of the electronic device can transmit the first information of the interested device to a relay nearest to the electronic device among one or more relays, and receive the second information of the interested device from the nearest relay. Specifically, the communication module of the electronic device can transmit the ID information of the interested device to the relay nearest to the electronic device which is searched among one or more relays. Thereafter, the communication module of the electronic device can receive the ID information of the interested device, the ID information of the relay nearest to the interested device, and the location information of the relay nearest to the interested device from the relay nearest to the electronic device. Herein, the communication module can enable communication with other electronic devices, such as a computer, a server and/or a portable terminal, through a wireless communication subsystem or an external port.

The touchscreen (805) of the electronic device can display the location information of the interested device based on the received second information. For example, in one embodiment, the electronic device receives an input for execution of a relevant application for displaying the location information of the interested device and then executes the application, a relay nearest to the interested device is a first relay and a relay nearest to the electronic device is a second relay. In addition, in one embodiment, the interested device is attached to a child's belongings, the electronic device is possessed by parents, and the child and the parents are located at a bookstore A. In the above embodiment, when the communication module of the electronic device receives the second information from the nearest relay, the touchscreen can display an indication that the electronic device is currently located near the second relay among one or more relays provided in the bookstore A and the second relay is located near “a fashion magazine corner” located in the second floor of the bookstore A. In addition, the touchscreen of the electronic device can display an indication that the interested device is currently located near the first relay among one or more relays provided in the bookstore A and the first relay is located near “a children's book corner” located in the first floor of the bookstore. In addition, the electronic device can display an indication that a distance from “the fashion magazine corner” located near the second relay at which the electronic device is currently located to “the children's book corner” located near the first relay at which the interested device is located is a one-floor distance. The touchscreen can use various display technologies. For example, the touchscreen 980 can use an LCD (liquid crystal display), an LED (Light Emitting Diode), an LPD (light emitting polymer display), an OLED (Organic Light Emitting Diode), an AMOLED (Active Matrix Organic Light Emitting Diode), or an FLED (Flexible LED).

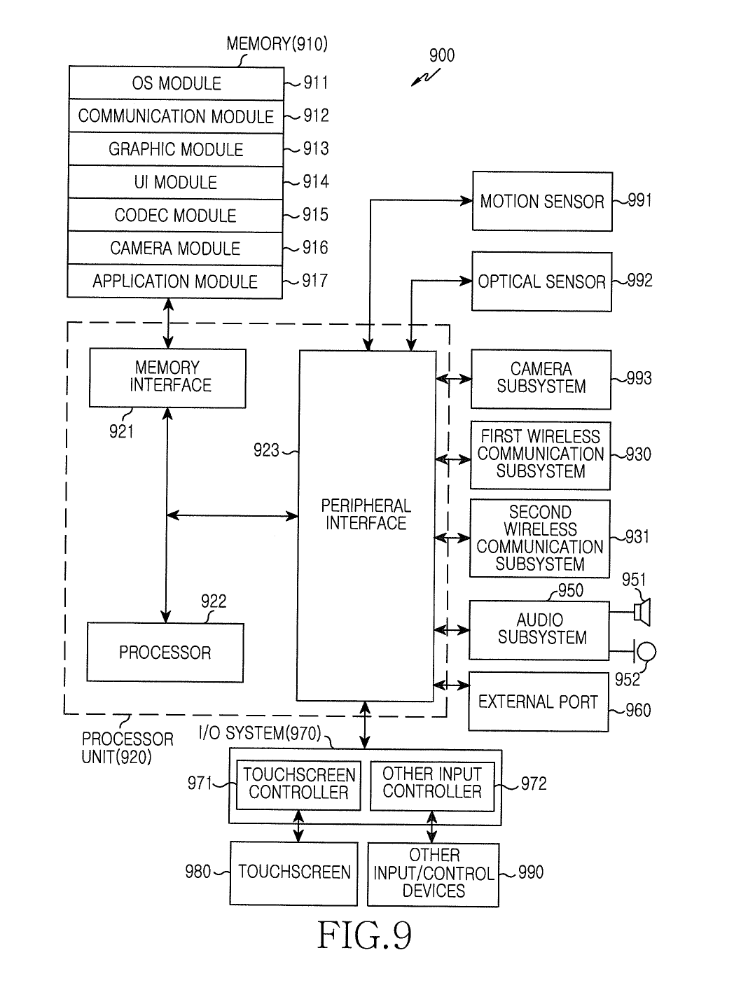

FIG. 9 illustrates a configuration of an electronic device according to an exemplary embodiment of the present disclosure. The electronic device 900 can be a portable electronic device, and examples thereof can include a portable terminal, a mobile phone, a mobile pad, a media player, a tablet computer, a handheld computer, or a Personal Digital Assistant (PDA), and the like. In addition, the electronic device can be any one portable electronic device including a device having two or more functions among the above-described devices.

The electronic device 900 includes a memory 910, a processor unit 920, a first wireless communication subsystem 930, a second wireless communication subsystem 931, an external port 960, an audio subsystem 950, a speaker 951, a microphone 952, an input/output (I/O) system 970, a touchscreen 980, and other input/control devices 990. The memory 910 and the external port 960 can be provided in plurality.

The processor unit 920 can include a memory interface 921, at least one processor 922, and a peripheral interface 923. In some cases, the processor unit 920 will also be referred to as a processor. The processor unit 920 according to the present disclosure executes an application for identifying the location information of the interested device and identifies the location information of the relay nearest to the interested device included in the second information.

The processor 922 executes various software programs to perform various functions for the electronic device 900, and performs processes and controls for voice communication and data communication. In addition to these general functions, the processor 922 executes a specific software module (instruction set) stored in the memory 910 and performs various specific functions corresponding to the software module. That is, the processor 922 performs methods of exemplary embodiments according to the present disclosure in cooperation with software modules stored in the memory 910.

The processor 922 can include at least one data processor, image processor, or codec. The data processor, the image processor, or the codec can be configured separately. Also, the processor 922 can be configured by a plurality of processors performing different functions. The peripheral interface 923 connects various peripheral devices and the I/O system 970 of the electronic device 900 to the processor 922 and the memory 910 (through the memory interface).

The various elements of the electronic device 900 can be coupled by at least one communication bus (not illustrated) or stream line (not illustrated).

The external port 960 is used to connect a portable electronic device (not illustrated) to other electronic devices directly or indirectly through a network (for example, Internet, intranet, or wireless LAN). The external port 960 can be, for example, a universal serial bus (USB) port or a FireWire port, but is not limited thereto.

A motion sensor 991 and an optical sensor 992 can be connected to the peripheral interface 923 to enable various functions. For example, the motion sensor 991 and the optical sensor 992 can be connected to the peripheral interface 923 to detect a motion of the electronic device, the amount of charge transfer, and light from the outside. In addition, other sensors, such as a location measurement system, a temperature sensor, or a bio sensor can connect to the peripheral interface 923 and perform a relevant function.

A camera subsystem 993 can perform camera functions such as photographing and video clip recording.

The optical sensor 992 can include a CCD (charged coupled device) or a CMOS (complementary metal-oxide semiconductor) device.

A communication function is performed through one or more wireless communication subsystems 930 and 931. The wireless communication subsystems 930 and 931 can include a radio frequency (RF) receiver and transceiver and/or an optical (e.g., infrared) receiver and transceiver. The first wireless communication subsystem 930 and the second wireless communication subsystem 931 can be divided according to communication networks through which the electronic device 900 communicate. For example, the communication networks can include, but not limited to, a GSM (Global System for Mobile Communication) network, an EDGE (Enhanced Data GSM Environment) network, a CDMA (Code Division Multiple Access) network, a W-CDMA (W-Code Division Multiple Access) network, an LIE (Long Term Evolution) network, an OFDMA (Orthogonal Frequency Division Multiple Access) network, a WiFi (Wireless Fidelity) network, a WiMax network, and/or a Bluetooth network. The first wireless communication subsystem 930 and the second wireless communication subsystem 931 can be integrated with each other as one wireless communication subsystem.

The audio subsystem 950 is connected to the speaker 951 and the microphone 952 to perform audio stream input/output functions such as voice recognition, voice replication, digital recording, and phone functions. That is, the audio subsystem 950 communicates with the user through the speaker 951 and the microphone 952. The audio subsystem 950 receives a data stream through the peripheral interface 923 of the processor unit 920 and converts the received data stream into an electric stream. The electric stream is transmitted to the speaker 951. The speaker 951 converts the electric stream into sound waves audible by humans and outputs the same. The microphone 952 converts sound waves received from humans or other sound sources into an electric stream. In addition, the microphone 952 is activated when one second sensor of at least two second sensors detects that a subject is located within a predetermined distance. The audio subsystem 950 receives an electric stream converted from the microphone 952. The audio subsystem 950 converts the received electric stream into an audio data stream and transmits the audio data stream to the peripheral interface 923. The audio subsystem 950 can include an attachable/detachable earphone, a headphone, or a headset.

The I/O system 970 can include a touchscreen controller 971 and/or another input controller 972. The touchscreen controller 971 can be connected to the touchscreen 980. The touchscreen 980 and the touchscreen controller 971 can detect a touch, a motion, or a stop thereof by using multi-touch detection technologies including a proximity sensor array or other elements, as well as capacitive, resistive, infrared and surface acoustic wave technologies for determining one or more touch points on the touchscreen 980. The other input controller 972 can be connected to the other input/control devices 990. The other input/control devices 990 can include one or more buttons, a rocker switch, a thumb wheel, a dial, a stick, and/or a pointer device such as a stylus.

The touchscreen 980 provides an I/O interface between the electronic device 900 and the user. That is, the touchscreen 980 transmits a user touch input to the electronic device 900. Also, the touchscreen 980 is a medium that displays an output from the electronic device 900 to the user. That is, the touchscreen 980 displays a visual output to the user. The visual output can be represented by a text, a graphic, a video, or a combination thereof.

The touchscreen 980 can use various display technologies. For example, the touchscreen 980 can use an LCD (liquid crystal display), an LED (Light Emitting Diode), an LPD (light emitting polymer display), an OLED (Organic Light Emitting Diode), an AMOLED (Active Matrix Organic Light Emitting Diode), or an FLED (Flexible LED). The touchscreen 980 according to the present disclosure displays the location information of the interested device based on the received second information and displays the location information of the relay nearest to the interested device and the location information of the interested device together.

The memory 910 can be connected to the memory interface 921. The memory 910 can include one or more high-speed random-access memories (RAMs) such as magnetic disk storage devices, one more nonvolatile memories, one or more optical storage devices, and/or one or more flash memories (for example, NAND flash memories or NOR flash memories).

The memory 910 stores software. Elements of the software include an operation system (OS) module 911, a communication module 912, a graphic module 913, a user interface (UI) module 914, a codec module 915, a camera module 916, and one or more application modules 917. Also, since the module that is an element of the software can be represented as a set of instructions, the module can be referred to as an instruction set. The module can also be referred to as a program. The OS module 911 (for example, WINDOWS, LINUX, Darwin, RTXC, UNIX, OS X, or an embedded OS such as VxWorks) includes various software elements for controlling general system operations. For example, general system operation controls can include memory control/management, storage hardware (device) control/management, and power control/management. The OS module also performs a function for enabling smooth communication between various hardware elements (devices) and software elements (modules).

The communication module 912 can enable communication with other electronic devices, such as computers, servers, and/or portable terminals, through the wireless communication subsystems 930 and 931 or the external port 960. The communication module 912 according to the present disclosure transmits the first information of the interested device to the relay nearest to the electronic device among one or more relays and receives the second information of the interested device from the nearest relay. In addition, the communication module 912 searches for the nearest relay among the one or more relays, connects to the searched nearest relay and performs communication in an encrypted packet form.

The graphic module 913 includes various software elements for providing and displaying graphics on the touchscreen 980. The graphics include texts, web pages, icons, digital images, videos, and animations.

The UI module 914 includes various software elements related to a user interface. Through the user interface module, the electronic device provides information about how the state of a user interface changes and/or information about under what condition the state of a user interface changes.

The codec module 915 can include software elements related to video file encoding/decoding. The codec module can include a video stream module such as an MPEG module or an H204 module. Also, the codec module can include various audio file codec modules such as AAA, AMR, and WMA. Also, the codec module 915 includes an instruction set corresponding to the implementation methods of the present disclosure.

The camera module 916 can include camera-related software elements that enable camera-related processes and functions.

The application module 917 includes a browser application, an e-mail application, an instant message application, a word processing application, a keyboard emulation application, an address book application, a touch list application, a widget application, a digital right management (DRM) application, a voice recognition application, a voice replication application, a position determining function application, a location-based service (LBS) application, and the like.

In addition, various functions of the electronic device 1000 according to the present disclosure, which have been described above and will be described below, can be implemented by any combination of hardware and/or software including one or more stream processings and/or an application-specific integrated circuit (ASIC).

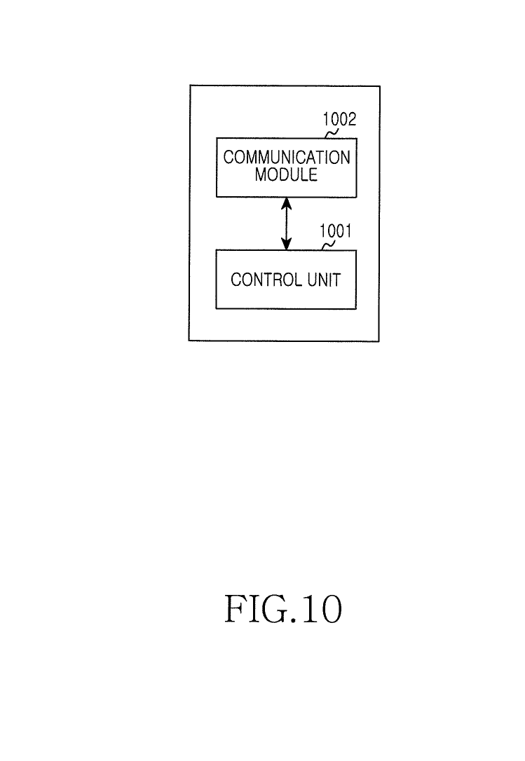

FIG. 10 illustrates a configuration of an interested device according to an exemplary embodiment of the present disclosure. As illustrated in FIG. 10, the interested device according to the present disclosure can include a control unit 1001 and a communication module 1002. First, the control unit 1001 controls an overall operation of the interested device.

The communication module 1002 processes signals transmitted and received through an antenna for voice and data communication. For example, the communication module 1002 transmits the ID information of the interested device to a relay nearest to the interested device among at least one relay at predetermined periods.

In the above-described block configuration, the control unit 1001 can perform an overall function of the interested device. Although the respective functions of the interested device are illustrated separately, the control unit 1001 can be configured to perform all or only some of the functions of the interested device.

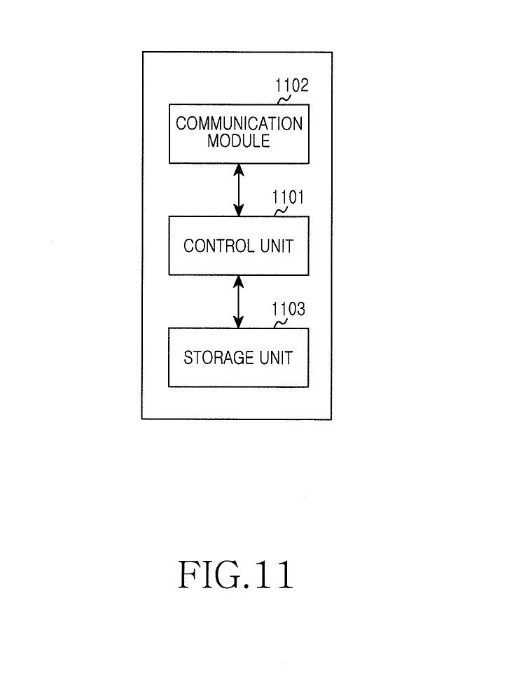

FIG. 11 illustrates a configuration of a relay according to an exemplary embodiment of the present disclosure. As illustrated in FIG. 11, the relay according to the present disclosure can include a control unit 1101, a communication module 1102 and a storage unit 1103. First, the control unit 1101 controls an overall operation of the relay.

The communication module 1102 processes signals transmitted and received through an antenna for voice and data communication. For example, the communication module 1102 receives the information of the device from the device at predetermined periods, and transmits the received first information to at least one relay nearest to the relay among one or more relays. Specifically, the communication module 1102 receives the ID information of the device from the device at predetermined periods, and transmits the received first information to the at least one relay nearest to the relay. For example, the communication module 1102 receives the first information from the electronic device, and transmits the second information received to the at least one relay nearest to the relay among one or more relays to the electronic device. Specifically, the communication module 1102 receives the ID information of the interested device from the electronic device, and transmits the ID information of the interested device and the ID information and location information of the relay nearest to the interested device, which are received from the at least one relay nearest to the relay among the one or more relays, to the electronic device. In addition, the communication module 1102 receives the second information from the at least one relay nearest to the relay at predetermined periods and performs communication in the encrypted packet form.

The storage unit 1103 can include a program storage unit for storing a program for controlling an operation of the relay, and a data storage unit for storing data generated during the execution of a program. For example, the storage unit 1103 can store second information received from the electronic device. Specifically, the storage unit 1103 can store the ID information of the interested device received from the electronic device, the ID information of a relay nearest to the interested device, and the location information of the relay nearest to the interested device.

While certain exemplary embodiments have been shown and described, it will be understood by those skilled in the art that various changes in form and details may be made therein without departing from the spirit and scope of the appended claims. Therefore, the scope of the applied for patent rights is defined not by the detailed description but by the appended claims.

What is claimed is:

1. A method in an electronic device, comprising:
transmitting first information of an interested device from a relay nearest to the electronic device among one or more relays;
receiving second information of the interested device from the nearest relay; and
displaying location information of the interested device based on the received second information.

2. The method of claim 1, further comprising executing an application for identifying the location information of the interested device.

3. The method of claim 1, further comprising:
searching for the nearest relay among the one or more relays; and
connecting to the searched nearest relay.

4. The method of claim 1, wherein the one or more layers are connected to one another through an encrypted communication channel.

5. The method of claim 1, wherein the first information of the interested device is ID information of the interested device.

6. The method of claim 1, wherein the second information of the interested device is ID information of the interested device, and ID information and location information of a relay nearest to the interested device among the one or more relays.

7. The method of claim 1, wherein transmitting the first information of the interested device and receiving the second information of the interested device from the nearest relay are performed in an encrypted packet form.

8. The method of claim 1, wherein displaying the location information of the interested device based on the received second information comprises:
identifying location information of a relay nearest to the interested device included in the second information; and
displaying the location information of the relay nearest to the interested device and the location information of the interested device together.

9. A method for operating a relay nearest to a device among one or more relays, comprising:
receiving information of the device from the device at predetermined periods; and
transmitting the received first information to the relay nearest to the device among the one or more relays.

10. The relay of claim 9, wherein the information of the device is ID information of the device.

11. A method for operating a first relay nearest to an electronic device among one or more relays, comprising:
receiving first information from the electronic device; and
transmitting the second information received from at least one relay nearest to the first relay among the one or more relays to the electronic device.

12. The method of claim 11, further comprising:
receiving the second information from the at least one relay nearest to the first relay at predetermined periods; and
storing the received second information.

13. The method of claim 11, wherein the first information is ID information of the interested device.

14. The method of claim 11, wherein the second information is ID information of the interested device, and ID information and location information of a second relay nearest to the interested device.

15. The method of claim 11, wherein the one or more relays are connected to one another through an encrypted communication channel.

16. The method of claim 11, wherein receiving the first information from the electronic device and transmitting the second information received from the at least one relay nearest to the first relay among the one or more relays to the electronic device are performed in an encrypted packet form.

17. An electronic device, comprising:
a communication module configured to transmit first information of an interested device to a relay nearest to the electronic device among one or more relays and receive second information of the interested device; and
a touchscreen configured to display location information of the interested device based on the received second information.

18. The electronic device of claim 17, further comprising a processor unit configured to execute an application for identifying the location information of the interested device.

19. The electronic device of claim 17, wherein the communication module is configured to search for the relay nearest to the electronic device among one or more relays and connects to the searched nearest relay.

20. The electronic device of claim 17, wherein the one or more relays are connected to one another through an encrypted communication channel.

21. The electronic device of claim 17, wherein the first information of the interested device is ID information of the interested device.

22. The electronic device of claim 17, wherein the second information of the interested device is ID information of the interested device, and ID information and location information of a relay nearest to the interested device among the one or more relays.

23. The electronic device of claim 17, wherein the communication module is configured to performs communication in an encrypted packet form.

24. The electronic device of claim 17, further comprising a processor unit configured to identify location information of a relay nearest to the interested device included in the second information,
wherein the touchscreen displays the location information of the relay nearest to the interested device and the location information of the interested device together.

25. A first relay nearest to a device among one or more relays, comprising:
a communication module configured to receive information of the device from the device at predetermined periods, and transmit the received first information to at least one relay nearest to the first relay among the one or more relays; and
a control unit configured to control an overall operation of the first relay.

26. The relay of claim 25, wherein the information of the device is ID information of the device.

27. A first relay nearest to an electronic device among one or more relays, comprising:
a communication module configured to receive first information from the electronic device and transmit a second information received from at least one relay nearest to the first relay among the one or more relays to the electronic device; and
a control unit configured to control an overall operation of the first relay.

28. The first relay of claim 27, further comprising a storage unit configured to store the received second information,
wherein the communication module receives the second information from the at least one relay nearest to the first relay at predetermined periods.

29. The first relay of claim 27, wherein the first information is ID information of the interested device.

30. The first relay of claim 27, wherein the second information is ID information of the interested device, and ID information and location information of a relay nearest to the interested device.

31. The first relay of claim 27, wherein the one or more layers are connected to one another through an encrypted communication channel.

32. The first relay of claim 27, wherein the communication module is configured to perform communication in an encrypted packet form.
